(19) United States
(12) Patent Application Publication
(10) Pub. No.: US 2025/0189123 A1
(43) Pub. Date: Jun. 12, 2025

(54) FISHTAIL FLAME BURNER ASSEMBLY

(71) Applicant: Selas Heat Technology Company LLC, Streetsboro, OH (US)

(72) Inventor: Scott C. Anderson, Orlando, FL (US)

(73) Assignee: Selas Heat Technology Company LLC, Streetsboro, OH (US)

(21) Appl. No.: 18/845,780

(22) PCT Filed: Mar. 14, 2022
(86) PCT No.: PCT/US2022/071132

§ 371 Date: Sep. 10, 2024

(51) Int. Cl. F23D 14/58; F23D 14/22; F23D 14/32

(52) U.S. Cl. CPC F23D 14/583; F23D 14/22; F23D 14/32; F23D 2900/00013

(57) ABSTRACT

A burner assembly including a body portion comprising a gas inlet configured to be in fluid communication with a gas source and a first cavity in fluid communication with the gas inlet. A gas nozzle extends between a first end coupled to the body portion and a second end. The gas nozzle has a second cavity in fluid communication with the first cavity of the body portion, the second cavity comprising a tapered, conical portion and a trapezoidal portion extending from within the conical portion to an outlet of the gas nozzle. A fuel tube is located at least partially within the first cavity of the body portion and the second cavity of the gas nozzle, the fuel tube having a fuel inlet configured to be in fluid communication with a fuel source and a fuel nozzle located within the through-bore of the gas nozzle, the fuel nozzle having a fuel outlet positioned near the second end of the gas nozzle.

### FIELD

The present disclosure is directed generally to gas-fired burners, and more specifically, to a fishtail flame burner assembly having a gas nozzle that provides internal combustion and a shaped flame.

### BACKGROUND

Oxy-fuel combustion is the process of burning a fuel using oxygen as the primary oxidant instead of air. Use of oxy-fuel combustion lowers harmful environmental emissions as the nitrogen component of the air oxidant is not heated, reducing NOx emissions, as well as decreasing fuel consumption. Burner assemblies typically have cylindrical gas nozzles due to ease of construction. However, different applications may require a differently shaped flame as compared to the flame generated by a cylindrical gas nozzle.

### SUMMARY

The present disclosure is directed generally to a burner assembly for oxy-fuel combustion. The burner assembly embodiments discussed herein include a gas nozzle with an inner fishtail configuration to advantageously shape the flame produced by the burner assembly.

One aspect of the present technology relates to a burner assembly including a body portion comprising a gas inlet configured to be in fluid communication with a gas source and a cavity in fluid communication with the gas inlet. A gas nozzle extends between a first end coupled to the body portion and a second end. The gas nozzle has a through-bore in fluid communication with the cavity of the body portion, the through-bore comprising a tapered, conical portion and a trapezoidal portion extending from within the conical portion to an outlet of the gas nozzle. A fuel tube is located at least partially within the cavity of the body portion and the through-bore of the gas nozzle, the fuel tube having a fuel inlet configured to be in fluid communication with a fuel source and a fuel nozzle encased within the through-bore of the gas nozzle, the fuel nozzle having a fuel outlet positioned near the second end of the gas nozzle.

In one aspect, the trapezoidal portion has a first width within the conical portion and a second width at the outlet, wherein the second width is greater than the first width.

In one aspect, a ratio of the first width to the second width is about 0.60.

In one aspect, the first width is in a range from about 0.85 inches to about 1.41 inches and the second width is in a range from about 1.39 inches to 2.31 inches.

In one aspect, the trapezoidal portion extends between the first width and the second width at an angle in a range from about 10 to 30 degrees.

In one aspect, the tapered, conical portion extends between a first height equal to a diameter of the second cavity to a second height at the trapezoidal portion, wherein the second height is less than the first height

In one aspect the tapered, conical portion extends between the first diameter and the second diameter at an angle of about 10-35 degrees.

In one aspect, a ratio of the second diameter to the first diameter is about 0.25.

In one aspect, the first height is in a range from about 1.13 inches to about 1.90 inches and the second height is in a range from about 0.37 inches to about 0.63 inches.

In one aspect, the outlet has a height in a range from about 0.37 inches to about 0.63 inches.

In one aspect, a ratio between the first width and the height of the outlet is in a range from about 1.5 to 3.0.

In one aspect, the burner assembly is submerged combustion burner.

In one aspect, the burner assembly further includes a water jacket surrounding the gas nozzle and at least a portion of the body portion. The water jacket provides a water passage between an inner wall of the water jacket and an outer wall of the gas nozzle and the at least a portion of the body portion.

In one aspect, the water jacket further comprises one or more water inlets for introducing water to the water passage.

According to another embodiment, a method of making a burner assembly is disclosed. A body portion comprising a gas inlet configured to be in fluid communication with a gas source and a first cavity in fluid communication with the gas inlet is provided. A first end of a gas nozzle is coupled to the body portion. The gas nozzle extends between the first end a second end and has a second cavity in fluid communication with the first cavity of the body portion. The second cavity includes a tapered, conical portion and a trapezoidal portion extending from within the conical portion to an outlet of the gas nozzle. A fuel tube is located at least partially within the first cavity of the body portion and the second cavity of the gas nozzle. The fuel tube has a fuel inlet configured to be in fluid communication with a fuel source and a fuel nozzle located within the second cavity of the gas nozzle. The fuel nozzle has a fuel outlet positioned near the second end of the gas nozzle.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The foregoing will be apparent from the following more particular description of example embodiments of the present disclosure, as illustrated in the accompanying drawings in which like reference characters refer to the same parts throughout the different views. The drawings are not necessarily to scale, emphasis instead being placed upon illustrating embodiments of the present disclosure.

FIG. 1 is a schematic perspective view of a burner assembly according to aspects of the present disclosure.

FIG. 2 is a schematic side view and block diagram of the burner assembly illustrated in FIG. 1 operatively coupled to a gas source and a fuel source according to aspects of the present disclosure.

FIG. 3 is a schematic front view of the burner assembly illustrated in FIG. 1 according to aspects of the present disclosure.

FIG. 4 is a schematic side cross-sectional view of the burner assembly illustrated in FIG. 1 according to aspects of the present disclosure.

FIG. 5 is a schematic side cross-sectional view of an end portion of the burner assembly illustrated in FIG. 1 according to aspects of the present disclosure.

FIG. 6 is a schematic top cross-sectional view of the end portion of the burner assembly illustrated in FIG. 1 according to aspects of the present disclosure.

FIGS. 7A and 7B are side and top schematic views of a gas nozzle of a burner assembly, respectively, according to aspects of the present disclosure. The dimensions illustrated in FIGS. 7A and 7B are exemplary and are not intended to be limiting.

FIGS. 8A and 8B are exemplary images of a flame produced by the burner assembly illustrated in FIG. 1 according to aspects of the present disclosure.

FIG. 9 is a schematic perspective view of an end portion of another burner assembly according to aspects of the present disclosure having a water jacket surrounding the gas nozzle.

FIG. 10 is a schematic side view of the end portion of the burner assembly illustrated in FIG. 9 according to aspects of the present disclosure.

FIG. 11 is a side, cross-sectional view of the end portion of the burner assembly illustrated in FIG. 9 according to aspects of the present disclosure.

FIG. 12 is an example process of making a burner assembly according to aspects of the present disclosure.

### DETAILED DESCRIPTION

The present disclosure is directed generally to a burner assembly for oxy-fuel combustion. The burner assembly embodiments discussed herein include a gas nozzle with an inner fish tail configuration to advantageously shape the flame produced by the burner assembly.

A description of example embodiments of the present disclosure follows. Although the burner assembly shown in the figures is shown in an upward orientation, the description of the assembly shown in the figures is not intended to be limited to a particular orientation.

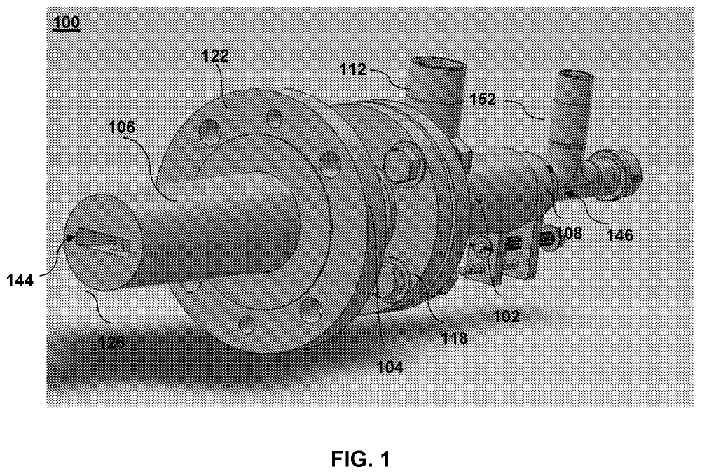

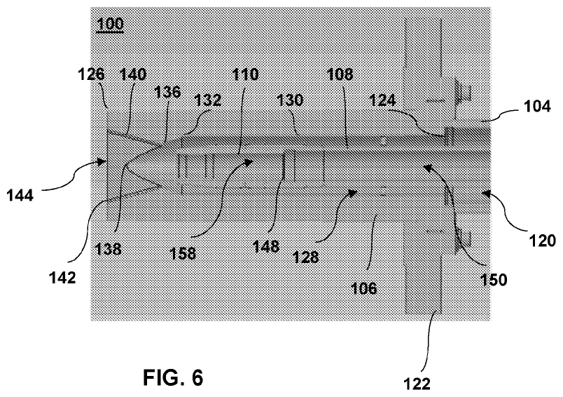

FIGS. 1-7B illustrate a burner assembly 100 according to the present disclosure. Burner assembly 100 includes first body portion 102, second body portion 104, gas nozzle 106, fuel tube 108, and fuel nozzle 110, although burner assembly 100 can include other types and/or numbers of elements in other combinations or configurations, such as flanges configured to couple various elements of burner assembly 100 to one another. Although first body portion 102 and second body portion 104 are illustrated and described, it is to be understood that burner assembly 100 can have other body configurations including other numbers of body portions or a single, unitary body. Burner assembly 100 advantageously provides a gas nozzle that has an inner fishtail shaped configuration that shapes the flame generated to provide a narrower flame along the vertical axis of the burner assembly than a cylindrical burner, while also providing a wider, flat flame along the horizontal axis of the burner assembly. Burner assembly 100 can be utilized, for example, as a submerged combustion burner, although burner assembly 100 can be used in other burner applications.

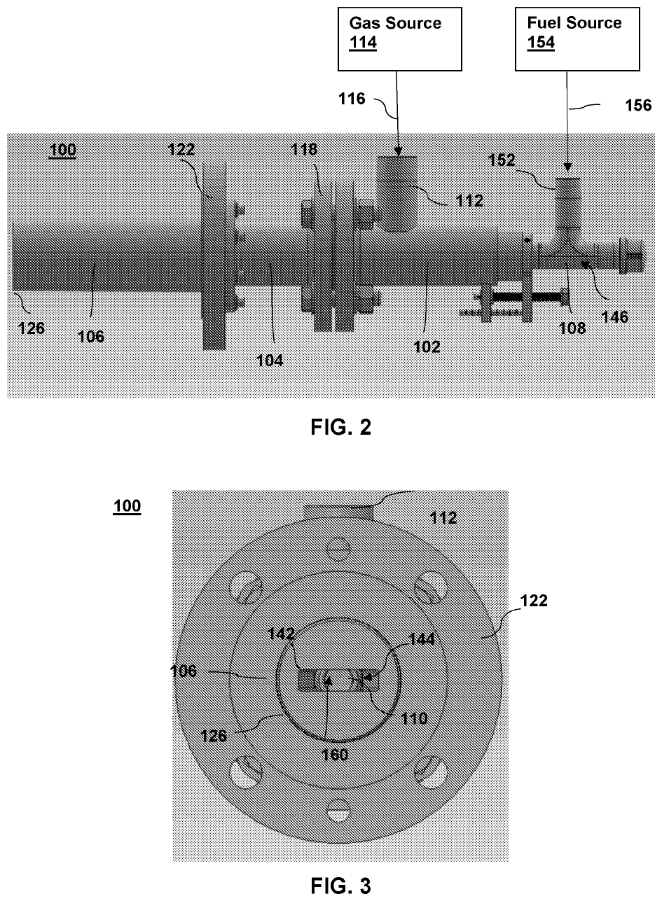

Referring now more specifically to FIG. 2, first body portion 102 includes gas inlet 112, which is configured to be in fluid communication with gas source 114 to provide supply of gas 116 for burner assembly 100. In one example, first body portion 102 is made from stainless steel and is substantially hollow. Although illustrated as an aperture within body 102, it should be appreciated that gas inlet 112 can take any form sufficient to provide the appropriate volume of gas 116 into first body portion 102 and subsequently into gas nozzle 106. In one example, the gas is oxygen or a gaseous mixture containing a substantial portion of oxygen. It should be appreciated that other gaseous mixtures could be utilized, e.g., gaseous mixtures comprising oxygen or any other gaseous oxidant that supports combustion processes.

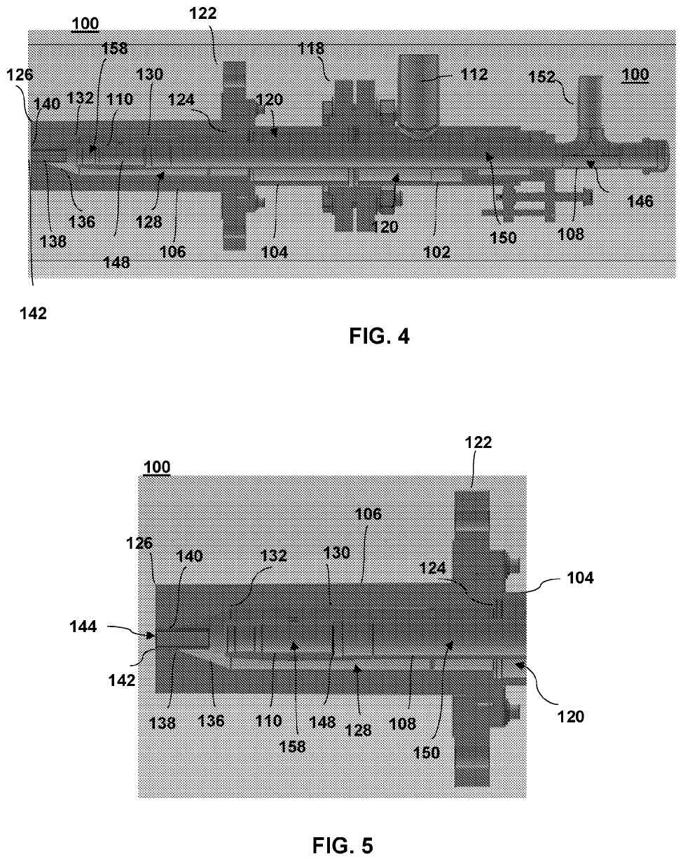

Second body portion 104 is coupled to first body portion 102 by first flange 118, although in other examples, burner assembly may comprise a single, unitary body. In one example embodiment, second body portion 102 is made from stainless steel and is substantially hollow. In this example, first body portion 102 and second body portion 104 define first cavity 120 (as shown in FIG. 4), which is in fluid communication with gas inlet 112 to receive gas 116 from gas source 114 (as shown in FIG. 2). Second body portion 104 is coupled to gas nozzle 106 by second flange 122 such that during operation gas 116 is delivered from gas inlet 112 to gas nozzle 106 through first cavity 120.

Referring now more specifically to FIGS. 4-6, gas nozzle 106 extends between first end 124 and second end 126. First end 124 is coupled to second body portion 104 through second flange 122. Gas nozzle 104 further includes second cavity 128 arranged to extend along the length of gas nozzle 106 from first end 124 to second end 126. Second cavity 128 is in fluid communication with first cavity 120 such that during operation gas 116 is delivered from gas inlet 112 through first cavity 120 to second cavity 128.

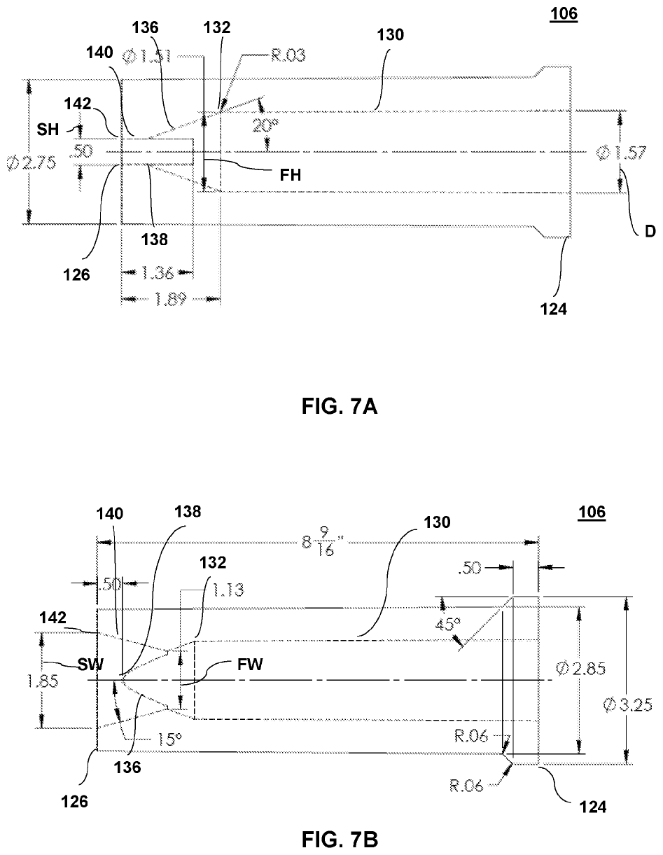

Referring now more specifically to FIGS. 4-7B, second cavity 128 includes cylindrical portion 130 that extends between first end 124 of gas nozzle 106 and cylindrical portion end 132 and has a diameter (D) (as shown in FIG. 7A). At cylindrical portion end 132, cylindrical portion 130 extends into tapered, conical portion 136 of second cavity 128. Tapered portion 136 forms a conical section within gas nozzle 106 that provides a reduced diameter compared to diameter (D) of cylindrical portion 132. The reduced diameter squeezes gas 116 that flows through cylindrical portion 132 of cavity 128 into a narrower, conical area to provide a narrower flow of gas 116. Tapered portion 136 extends between cylindrical portion end 132 and tapered portion end 138. In one example, tapered portion 136 extends from cylindrical portion end 132 at an angle of about 20 degrees, although the angle at which the tapered portion 136 extends from cylindrical portion end 132 may range from about 10 degrees to about 45 degrees. As shown in FIG. 7A, tapered portion 136 has a first height (FH) at cylindrical portion end 132 that is equal to diameter 134 of cylindrical portion 130 and a second height (SH) at tapered portion end 138, wherein SH is less than FH. In one example, a ratio of SH to FH is about 0.25, although the ratio of SH to FH may be about 0.15 to about 0.45 in other examples. In one example, FH is about 1.51 inches and SD is about 0.5 inches. In other examples, FH is in a range from about 1.13 inches to about 1.90 inches and SH is in a range from about 0.37 inches to about 0.63 inches.

Referring again to FIGS. 4-7B, second cavity 128 further includes trapezoidal portion 140 between first trapezoidal portion end 142 located within tapered portion 136 to outlet 144 of burner assembly 100. As illustrated in FIG. 7B, trapezoidal portion 140 has a first width (FW) at first trapezoidal portion end 142 within tapered portion 136 portion and a second width (SW) at outlet 144. In one example, trapezoidal portion 142 extends between first trapezoidal portion end 142 and outlet 144 at an angle of about 15 degrees, although in other examples the angle may range from about 10 degrees to about 30 degrees. The angle is dependent on the length of the trapezoidal portion 142. In this example, SW is greater than FW, such that trapezoidal portion 136 is advantageously configured to provide a wider, flat flame generated by burner assembly 100. In one example, FW is about 1.13 inches and SW is about 1.85 inches. In other examples, FW is in a range from about 0.85 inches to about 1.41 inches and SW is in a range from about 1.39 inches to about 2.31 inches. In this example, outlet 144 has a height of about 0.5 inches, although in other examples, the height of outlet 144 is in a range from about 0.37 inches to about 0.63 inches. The ratio between FW and the height of outlet 144 advantageously provides the flame configuration as described below. In this example, the ratio between FW (1.13 inches) and the height of the outlet 144 (0.5 inches) is about 2.26, although in other examples, the ratio may be between 1.5 and 3.0.

Referring now to more specifically to FIG. 4, fuel tube 108 includes first end 146 and second end 148. Fuel tube 108 further includes through-bore 150 arranged within fuel tube 108 and extending between first end 146 and second end 148 of fuel tube 108. Fuel tube 108 includes a fuel inlet 152 located near first end 146 thereof. Fuel inlet 152 is configured to be in fluid communication with fuel source 154, e.g., a source of fuel 156 (as shown in FIG. 2). Fuel 156 can be selected from: Methane, Propane, Butane, Hydrogen, Natural Gas, Carbon Monoxide, or any other gaseous fuel capable of auto-ignition at high temperatures. Through-bore 150 is arranged such that fuel 156 can flow through through-bore 150 and out of second end 148. Fuel tube 108 is located at least partially in first cavity 120 of first body portion 102 and second body portion 104 and extends within first cavity 120 from first body portion 102, to second body portion 104, and into second cavity 128 of gas nozzle 106. Fuel tube 108 is concentric with first cavity 120 and second cavity 128.

Additionally, second end 148 of fuel tube 108 is configured to receive fuel nozzle 110. In this example, fuel nozzle 110 is located entirely within second cavity 128 of gas nozzle 106. Fuel nozzle 108 is arranged to engage with and be removably secured to second end 148 of fuel tube 108. Fuel nozzle 108 further includes through-bore 158 which is substantially concentric with through-bore 150 of fuel tube 108. Through-bore 158 terminates at fuel outlet 160 and has a nozzle diameter (ND). ND is selected such that fuel 156 (shown in FIG. 2) can flow through through-bore 150 of fuel tube 108 and through-bore 158 of fuel nozzle 108 and out of fuel outlet 160. Fuel outlet 160 is located proximate to cylindrical portion end 132 such that fuel outlet 160 delivers fuel 156 into tapered section 130 where the flow of gas 116 is squeezed or compressed by the decrease in diameter between FD and SD as shown in FIGS. 7A and 7B. In this example, combustion takes place within gas nozzle 106 and thus the flow rate of fuel 156 (shown in FIG. 2) must be sufficient to avoid backfiring with burner assembly 100.

An exemplary operation of burner assembly 100 will now be described with reference to FIGS. 1-8. During operation, gas source 114 connected to gas inlet 112 provides gas 116 which flows through gas inlet 112 into first cavity 120 of first body portion 102 and second body portion 104 of burner assembly 100. First cavity 120 is sufficiently voluminous to accept gas 116 and redirect it, around the volume taken up by fuel tube 108 and fuel nozzle 110, into first end 124 of gas nozzle 106, along second cavity 128 of gas nozzle 106, and out of second end 126 of gas nozzle 106 at outlet 144. Tapered portion 136 compresses the flow of gas 116 near fuel outlet 160 of fuel nozzle 110.

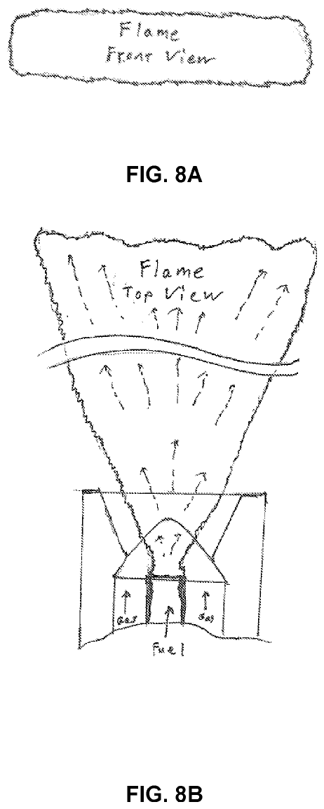

Simultaneously, fuel source 152 connected to fuel tube 108 provides fuel 156 which flows from first end 146 of fuel tube 108 to second end 148 of fuel tube 108 through through-bore 150, into through-bore 158 of fuel nozzle 110 and out into tapered portion 136 of gas nozzle 106. Once gas 116 and fuel 156 mix, the temperature experienced in tapered portion 136 is sufficient for auto-ignition of the gas-fuel mixture, which creates the combustion for burner assembly 100. The tapered portion 136 advantageously compresses gas 116 around fuel outlet 160 to generate a narrower flame. The flow of the gas-fuel mixture is then introduced into trapezoidal portion 140 to provide a wider, flat flame at outlet 144. FIGS. 8A and 8B illustrate an image of the flame produced by burner assembly 100. As combustion is taking place inside burner assembly 100, the flow rate of fuel 156 must be sufficient to avoid backfiring. In this example, gas nozzle 106 is air-cooled, although in other examples, as described below, a water jacket may be employed to reduce the operating temperature. It should be appreciated that, although not shown, an ignitor can be provided such that combustion does not rely on auto-ignition as described herein.

As discussed above, the burner assembly is intended to operate using oxyfuel combustion with a ratio of gas to fuel of about 1.5-3 (gas):1 (fuel). Further, the burner assembly 100 is intended to operate at %4 million btu/hr to about 20 million btu/hr.

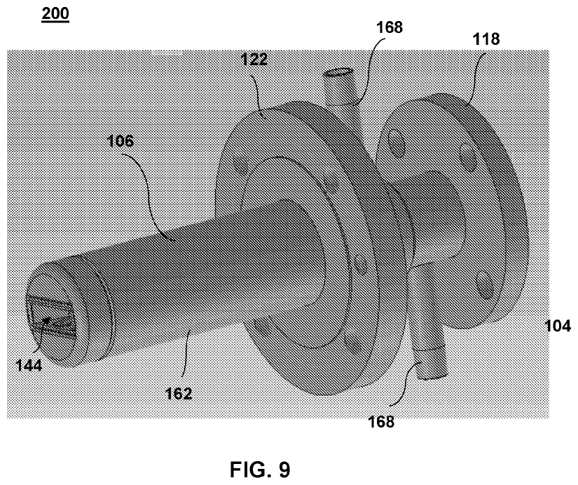

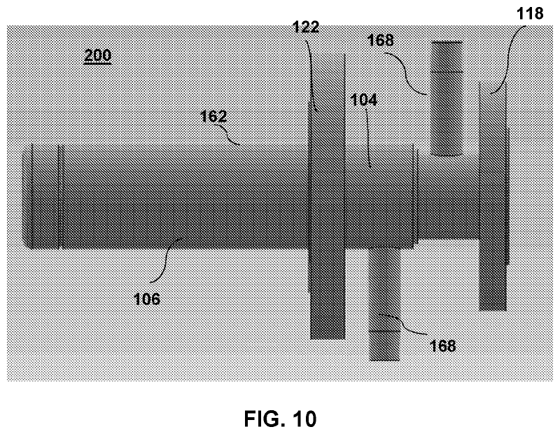

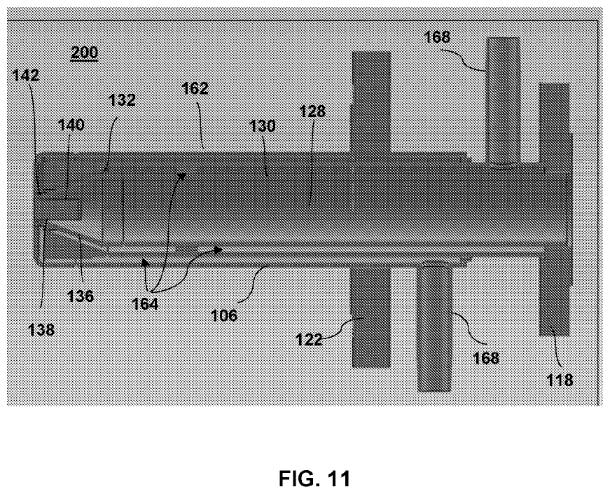

FIGS. 9-11 illustrate an end portion of another exemplary embodiment of a burner assembly according to the present disclosure. Burner assembly 200 is the same in structure and operation as burner assembly 100 except as described below and like elements are identified using like reference numerals. Burner assembly 200 provides a water-cooled version of burner assembly 100, which is air-cooled, although other fluids may be used with burner assembly 200 to provide cooling. Burner assembly 200 advantageously provides enhanced cooling to reduce operating temperatures as combustion occurs within gas nozzle 106.

Referring again to FIGS. 9-11, burner assembly 200 further includes water jacket 162 located around and surrounding gas nozzle 106 and at least a portion of second body portion 104. Water jacket 162 includes water passageways 164 located between inner wall 166 of water jacket 162 and outer wall 168 formed by gas nozzle 106 and a portion of second body portion 104. In this example, second body portion 104 includes water inlets 168 that are in fluid communication with a water source (not shown) and with water passageways 164 to provide water around gas nozzle 106. During operation of burner assembly 200, cooling fluid is provided from water source 170 through water inlets 168 to water passages 164 and is circulated around gas nozzle 106 to reduce operating temperatures of burner assembly 200.

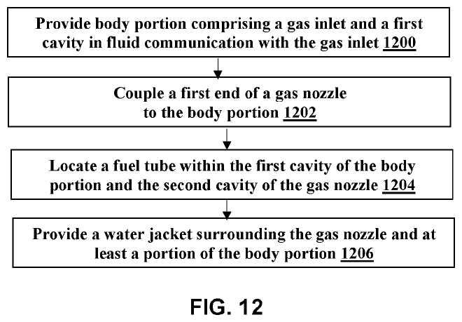

FIG. 12 illustrates an exemplary method of making a burner assembly according to an aspect of the present technology. First, in step 1200, a body portion comprising a gas inlet configured to be in fluid communication with a gas source and a first cavity in fluid communication with the gas inlet is provided. In step 1202, a first end of a gas nozzle is coupled to the body portion. When coupled, the gas nozzle has a second cavity in fluid communication with the first cavity of the body portion. The second cavity of the gas nozzle includes a tapered, conical portion and a trapezoidal portion extending from within the conical portion to an outlet of the gas nozzle. Next, in step 1204, a fuel tube is located at least partially within the first cavity of the body portion and the second cavity of the gas nozzle. The fuel tube has a fuel inlet configured to be in fluid communication with a fuel source and a fuel nozzle located within the second cavity of the gas nozzle. The fuel nozzle includes a fuel outlet positioned near the second end of the gas nozzle. In optional step 1206, a water jacket is provided surrounding the gas nozzle and at least a portion of the body portion. The water jacket provides a water passage between an inner wall of the water jacket and an outer wall of the gas nozzle and the at least a portion of the body portion.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

1. A burner assembly, comprising:
a body portion comprising a gas inlet configured to be in fluid communication with a gas source and a first cavity in fluid communication with the gas inlet;
a gas nozzle extending between a first end coupled to the body portion and a second end, the gas nozzle having a second cavity in fluid communication with the first cavity of the body portion, the second cavity comprising a tapered, conical portion and a trapezoidal portion extending from within the conical portion to an outlet of the gas nozzle; and
a fuel tube located at least partially within the first cavity of the body portion and the second cavity of the gas nozzle, the fuel tube having a fuel inlet configured to be in fluid communication with a fuel source and a fuel nozzle located within the second cavity of the gas nozzle, the fuel nozzle having a fuel outlet positioned near the second end of the gas nozzle.

2. The burner assembly of claim 1, wherein the trapezoidal portion has a first width within the tapered, conical portion and a second width at the outlet, wherein the second width is greater than the first width.

3. The burner assembly of claim 2, wherein a ratio of the first width to the second width is about 0.60.

4. The burner assembly of claim 2, wherein the first width is in a range from about 0.85 inches to about 1.41 inches and the second width is in a range from about 1.39 inches to 2.31 inches.

5. The burner assembly of claim 1, wherein the tapered, conical portion extends between a first height equal to a diameter of the second cavity to a second height at the trapezoidal portion, wherein the second height is less than the first height.

6. The burner assembly of claim 5 wherein the first height is in a range from about 1.13 inches to about 1.90 inches and the second height is in a range from about 0.37 inches to about 0.63 inches.

7. The burner assembly of claim 1, wherein the outlet has a height in a range from about 0.37 inches to about 0.63 inches.

8. The burner assembly of claim 1, wherein a ratio between a first width and a height of the outlet is in a range from about 1.5 to 3.0.

9. The burner assembly of claim 1, further comprising:
a water jacket surrounding the gas nozzle and at least a portion of the body portion, the water jacket providing a water passage between an inner wall of the water jacket and an outer wall of the gas nozzle and the at least a portion of the body portion.

10. The burner assembly of claim 9, wherein the water jacket further comprises one or more water inlets for introducing water to the water passage.

11. A method of making a burner assembly, the method comprising:
providing a body portion comprising a gas inlet configured to be in fluid communication with a gas source and a first cavity in fluid communication with the gas inlet;
coupling a first end of a gas nozzle to the body portion, the gas nozzle extending between the first end and a second end, the gas nozzle having a second cavity in fluid communication with the first cavity of the body portion, the second cavity comprising a tapered, conical portion and a trapezoidal portion extending from within the conical portion to an outlet of the gas nozzle; and
locating a fuel tube at least partially within the first cavity of the body portion and the second cavity of the gas nozzle, the fuel tube having a fuel inlet configured to be in fluid communication with a fuel source and a fuel nozzle located within the second cavity of the gas nozzle, the fuel nozzle having a fuel outlet positioned near the second end of the gas nozzle.

12. The method of claim 11, wherein the trapezoidal portion has a first width within the tapered, conical portion and a second width at the outlet, wherein the second width is greater than the first width.

13. The method of claim 12, wherein a ratio of the first width to the second width is about 0.60.

14. The method of claim 12, wherein the first width is in a range from about 0.85 inches to about 1.41 inches and the second width is in a range from about 1.39 inches to 2.31 inches.

15. The method of claim 11, wherein the tapered, conical portion extends between a first height equal to a diameter of the second cavity to a second height at the trapezoidal portion, wherein the second height is less than the first height.

16. The method of claim 15, wherein the first height is in a range from about 1.13 inches to about 1.90 inches and the second height is in a range from about 0.37 inches to about 0.63 inches.

17. The method of claim 11, wherein the outlet has a height in a range from about 0.37 inches to about 0.63 inches.

18. The method of claim 11, wherein a ratio between a first width and a height of the outlet is in a range from about 1.5 to 3.0.

19. The method of claim 11, further comprising:
providing a water jacket surrounding the gas nozzle and at least a portion of the body portion, the water jacket providing a water passage between an inner wall of the water jacket and an outer wall of the gas nozzle and the at least a portion of the body portion.

20. The method of claim 19, wherein the water jacket further comprises one or more water inlets for introducing water to the water passage.
